(19) United States
(12) Patent Application Publication
(10) Pub. No.: US 2008/0002724 A1
(43) Pub. Date: Jan. 3, 2008

(54) Method and apparatus for multiple generic exclusion offsets for security protocols

(76) Inventors: Karanvir Grewal, Hillsboro, OR (US); David Durham, Hillsboro, OR (US); Hormuzd Khosravi, Portland, OR (US); Men Long, Hillsboro, OR (US); Prashant Dewan, Hillsboro, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/479,157

(22) Filed: Jun. 30, 2006

(51) Int. Cl. H04L 12/56

(52) U.S. Cl. 370/401

(57) ABSTRACT

A method and apparatus to define multiple zones in a data packet for exclusion from processing by security operations of a security protocol. In one embodiment, each defined zone has an associated list of security operations from which the zone is protected.

### RELATED APPLICATIONS

The present U.S. application is related to the following U.S. Patent application filed concurrently:

(1) Application No. 11/XXX,XXX (Docket No. P24532), filed June ______, 2006, entitled “METHOD AND APPARATUS FOR MULTIPLE INCLUSION OFFSETS FOR SECURITY PROTOCOLS.”

### BACKGROUND

1. Field of the Invention

The invention relates generally to network security protocols. More particularly, the invention relates to selectively protecting zones in a data packet during a protocol's security processing.

2. Background Art

Network access control is used to limit network resource access only to those platforms that meet certain criteria for admission. Traditionally, this control is based on machine/user authentication, enforced at the network port level. The protocols used to enforce this control are typically based on standards like the Institute of Electrical and Electronics Engineers (IEEE) 802.1X (Standards for Local and Metropolitan Area Networks: Port based Network Access Control, IEEE Std 802.1X-2001, June 2001) or the Extensible Authentication Protocol (EAP) (L. Blunk and J. Vollbrecht, “PPP Extensible Authentication Protocol (EAP)”, RFC 2284, March 1998). It should be noted that references herein to “IEEE 802.1X” (capital “X”) should not confused with “IEEE 802.1x” (lower case “x”), a reference to IEEE 802.1-type protocols generally.

The introduction of technologies such as IEEE 802.1X for secure network access in a wired environment has imposed the requirement that each entity be connected to a distinct physical port. This limitation precludes the usage of aggregation devices such as hubs, which are freely used in today's network environments. It requires replacement of these network aggregators with distinct port-based network access control devices. This may be viable in an administrator controlled network, where introduction of aggregators such as hubs is strictly prohibited. However, in an environment where a single device may contain multiple personas, the device implicitly acts as a hub and the admin-type restrictions cannot be imposed. As virtualization becomes more popular, the problem of extending network support to aggregated and/or virtual entities grows.

Virtualization is an example of one emerging technology that relies on multiple entities distinguishing themselves while connected to a single port. Without a way to distinguish these entities, essential technologies are no longer available. One example of these technologies is Receive Side Scaling (RSS). RSS typically works in a multiple processor system, whereby a low Open Systems Interconnection (OSI) layer hardware device assigns the inbound data packets to a given processor, based on the OSI layer 3/layer 4 header information available in the packet. This may be used to perform load balancing on a multiple-processor system, where only one processor (and associated memory buffers) contain state information for certain types of outbound streams (e.g. TCP) and the other processor (and associated memory buffers) contain state information for other types of streams.

In order for the architecture to be affective, the inbound streams related to a particular outbound stream must be processed on the same processor, using the state information in the memory buffers. The decision to allocate a given inbound stream to a given processor is typically handled on low OSI levels in the hardware for performance reasons. In this scenario, if one entity cannot be distinguished from another, then this existing, widely used technology cannot function either for virtualization or for legacy technologies relying on aggregators. This is one example of the technology impacted when entity identifiers, usually in the form of user data in a data packet header, being unavailable to the supporting technology. There are many other technologies, e.g. Virtual LAN (VLAN), that are equally impacted on the transmit and receive sides, if user data in a data packet is rendered inaccessible by a protocol.

The currently available technology for secure network access does not facilitate models for upcoming technologies, such as virtualization, where multiple personas may be present within a single device. Any attempt to extend the current model of network access and allow multiple entities to connect to a physical port must not conflict with other technologies supporting network security and efficiency. One example of a potentially conflicting technology is that of Media Access Control (MAC). The current art for MAC layer security imposes some limitations in that it can result in encryption of the entire user data. Under formats of MAC Sec security frames such as IEEE 802.1AE (Draft Standards for Local and Metropolitan Area Networks: Media Access Control (MAC) Security, IEEE P802.1AE/D5.1, January 2006), all data beyond the OSI layer 2 MAC addresses and the IEEE 802.1AE header are encrypted. While providing protection between adjacent systems, this has implications for existing technologies deployed on end-point systems, which are circumvented by obscuring the higher OSI layer data fields.

The IEEE 802.1AE standard provides a valuable security service, solving real security threats in a wired environment. The challenge in connecting multiple entities to a single port is to allow technology like IEEE 802.1AE to be used in a secure manner and allow existing, widely deployed technologies to function normally.

### BRIEF DESCRIPTION OF THE DRAWINGS

FIG. 1 is a block diagram showing multiple virtual entities on a single machine connected to a single port of a network node.

FIG. 2 is a block diagram showing multiple entities connected to a single port of a network node via an aggregation device.

FIG. 3 is a block diagram showing connection of an entity to a port according to traditional network access.

FIG. 4 is a block diagram showing connection of multiple entities to a port.

FIG. 5 is a data packet diagram showing an embodiment having a MAC address as an entity identifier.

FIG. 6 is a data packet diagram showing an embodiment having entity identity information in an IEEE 802.1 AE-type packet header.

FIG. 7 is a data packet diagram showing how IEEE 802.1AE-type packet security does not allow TCP checksum offload to be delegated to a hardware device.

FIG. 8 is a data packet diagram showing an exclusion zone (EZ) header.

FIG. 9 is a data packet diagram showing a generic header and multiple EZ headers.

FIG. 10 is a data packet diagram showing EZ header extensions located in an IEEE 802.1AE-type header.

FIG. 11 is a flow diagram for a technique for marking EZs in a data packet.

FIG. 12 is a data packet diagram showing an inclusion zone (IZ) header.

FIG. 13 is a data packet diagram showing a generic header and multiple IZ headers.

FIG. 14 is a block diagram showing an architecture supporting EZ and IZ information.

### DETAILED DESCRIPTION

Techniques and architectures for protecting zones in a data packet during security processing are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions which follow are presented in terms of algorithms and symbolic representations of operations on data bits within a computer memory. These algorithmic descriptions and representations are the means used by those skilled in the networking arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms forms data represented as physical (electronic) quantities within the computer system's registers and memories into other data similarly represented as physical quantities within the computer system memories or registers or other such information storage, transmission or display devices.

Embodiments of the invention also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

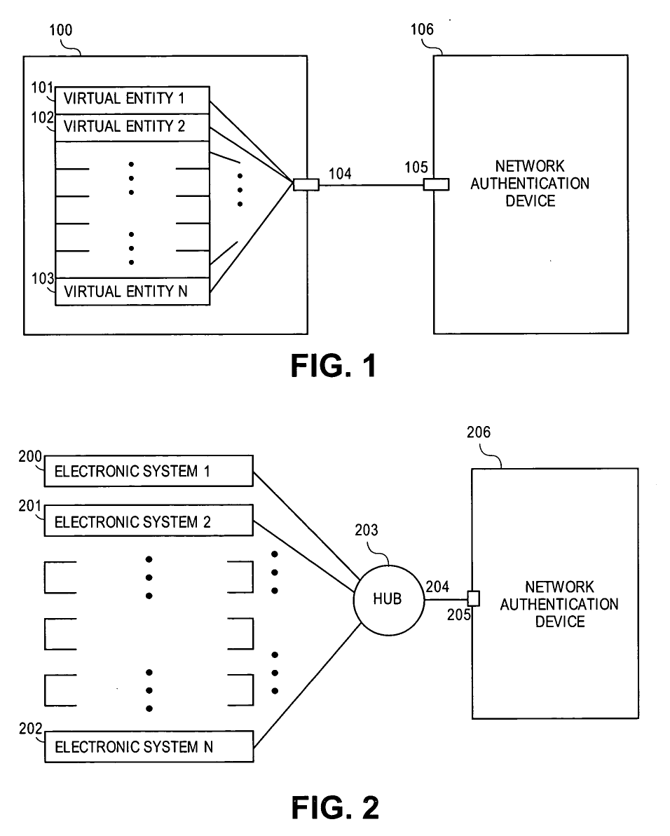

FIG. 1 shows multiple virtual entities existing on a single machine that may be connected to a single port of a Network Authentication Device (NAD). The NAD 106 can be any network node that is configured to distinguish entities connected to its port 105. In this example, a single computer 100 supports a plurality of virtual entities 101-103. Various types of virtual entities can be connected to the NAD, and various types of virtualization may be utilzied. Via a single port 105, the NAD 106 has a connection 104 to the single computer 100. To share the single connection 104, the virtual entities 101-103 distinguish themselves from one another by providing the NAD 106 with distinguishing identifiers. More particularly, to share a secure connection 104, the accessibility of the distinguishing identifiers must be protected from obscuring by network protocols that obscure such information for network nodes relying on legacy technologies. Accessibility is preserved for legacy technologies in part by selectively controlling processing by security operations of a protocol as that processing is applied to zones of the data packet.

FIG. 2 shows an alternative example wherein multiple entities connected to a single port of a network node via an aggregation device. The entities are described generically as electronic systems 200-202, which may mean any of a variety of network nodes, virtual entities, operating systems, and the like. Any of the electronic systems in FIG. 2 could further comprise a combination of multiple virtual and/or aggregated entities. The electronic systems 200-202 are aggregated in this case through a hub 203, which has a single connection 204 to the port 205 of an NAD 206 similar to that discussed in FIG. 1. As with the above example, the aggregated electronic systems 200-202 may not be able to securely share the connection 204 without providing distinguishing identifiers that remain accessible throughout current network security protocols.

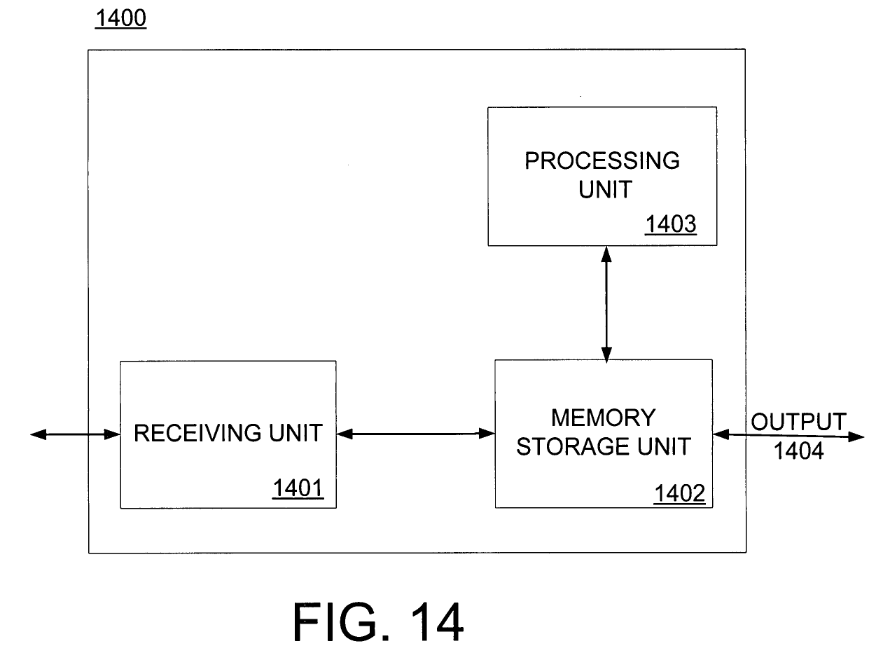

FIG. 14 is a block diagram showing an exemplary architecture for a NAD 106, 206 configured to handle data packets according to an embodiment of the invention. The architecture is applicable for implementing an embodiment of the invention as a system, an apparatus, or machine-readable instructions to implement the method described herein. The architecture 1400 includes a receiving unit 1401 to receive data packets via a port 105, 205. The receiving unit 1401 communicates with a memory storage unit 1402 to store said data packets. A processing unit 1403 is in communication with the memory storage unit 1402 to perform security operations on the stored data packets. Finally, an output 1404 from the memory storage unit 1402 is provided to transmit processed data packets.

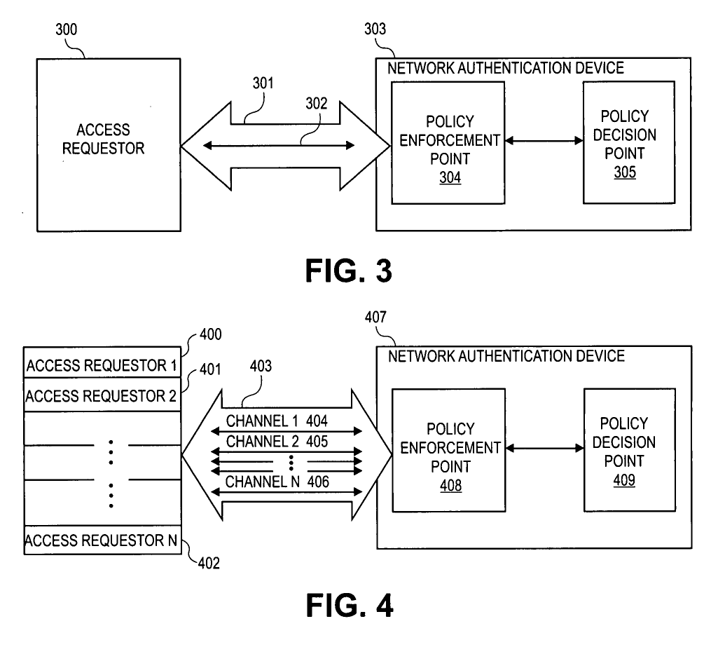

FIG. 3 illustrates the connection of a single entity to a port according to traditional network access. This diagram shows a typical wired model for port-based authentication, as when leveraging IEEE 802.1X. A single entity, the Access Requestor 300 (AR) tries to establish a connection 301 with the NAD 303 via the Policy Enforcement Point 304 (PEP). In this model, on a successful authentication, the PEP 304 will open a channel 302 and allow the AR 300 using the channel 302 to pass traffic.

FIG. 4 illustrates one embodiment of connection of multiple entities to a port. In this model, although there is still a single connection 403 to the NAD 407, there are multiple AR entities 400-402 and multiple network access channels 404-406 being initiated via that connection 403. Again, these multiple AR entities 400-402 could be multiple physical devices connected via an aggregation device (such as a hub), multiple operating systems within a single machine, various types of virtual entities, and the like. When the multiple AR entities 400-402 are initiating multiple network access channels 404-406, the PEP 408 may account for the fact that each channel is independent of the other and needs to be distinguished on the PEP 408. Otherwise, the PEP 408 would not be able to open the entire connection 403 on successful completion of network admissions, as this would allow any other entity sharing that connection 403 to have access to the network. Instead, the PEP 408 may differentiate between each authentication request and subsequently only allow data flow into/from the network for the successfully authenticated entities.

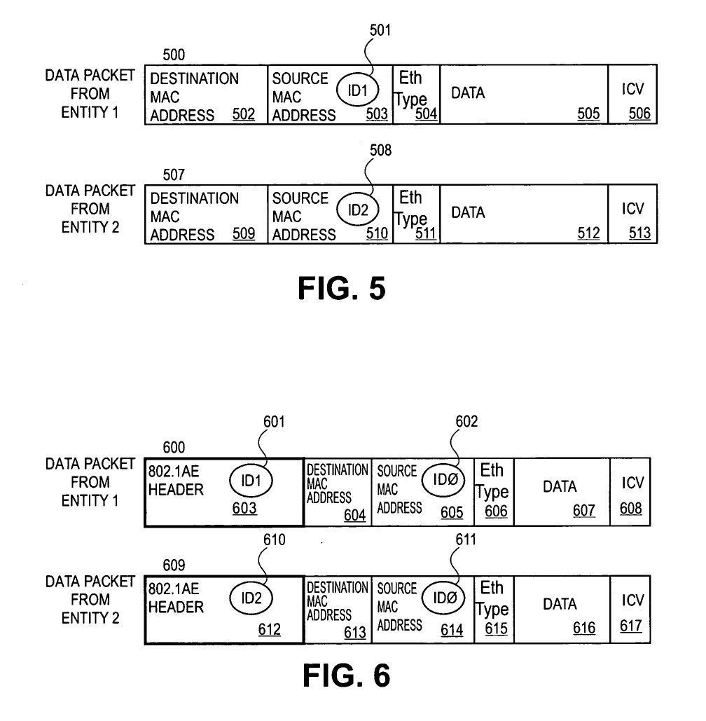

By way of illustration and not limitation, an embodiment of the invention is shown to provide a way for the multiple entities to be distinctly identifiable, in this case by providing information at the OSI layer 2 header of each data packet. FIG. 5 shows two data packets received from different entities via a shared connection 104, 204. In this example, both the first data packet 500 from Entity 1 and the second data packet 507 from an Entity 2 have a destination Media Access Control (MAC) address 502, 509, a source MAC address 503, 510, an ethertype field 504, 511, a data field 505, 512, and an integrity check value 506, 513. Some portions of the data packets 500, 507 are omitted for abbreviation.

To distinguish the source of these data packets 500, 507, the respective data packets may include a first unique identifier ID1 501 and a second unique identifier ID2 508. In this embodiment, ID1 501 may be kept as a source MAC address 503 of the first data packet 500 which differs from the ID2 508 kept as a source MAC address 510 of the second data packet 507. Thereby, the data packets received from multiple entities via a shared connection may be distinguished.

Making distinctions in this manner may be vulnerable to spoofing attacks, whereby once the port is open, a second entity connected to that port is able to gain access to the network. To mitigate this threat, security channels may be provided for each authenticated entity, whereby discrete cryptographic keys may be bound to the authentication process of each entity and subsequently leveraged by securing the data channel. In one embodiment, the entity identifier in the data packet may be associated with security attributes applicable to the entity, which allows the data packet to be encapsulated according to said security attributes.

Currently, a common MAC address may be shared by the multiple entities, while differentiating data packets from those entities based on another form of unique identifier—e.g. a distinct identity within the IEEE 802.1AE packet header. FIG. 6 shows an entity identifier which is contained in a IEEE 802.1 AE-type packet header. The unique entity identifier may also be associated with a particular set of security attributes, as described above. By way of illustration and not limitation, FIG. 6 also shows two data packets received from different entities via a shared connection 104, 204. Both the first data packet 600 from Entity 1 and the second data packet 609 from an Entity 2 may be an IEEE 802.1AE header 603, 612, a destination MAC address 604, 613, a source MAC address 605, 614, an ethertype field 606, 615, a data field 607, 616, and an integrity check value 608, 617. Some portions of the data packets 600, 609 are omitted for abbreviation.

The source MAC address 604 of the first data packet 600 may hold an identifier IDØ 602 which is the same as the identifier IDØ 611 held in the source MAC address 614 of the second data packet 609. To distinguish the source of these data packets 600, 609, unique identifiers in the IEEE 802.1AE headers 603, 612 may be utilized. In this example, Entity 1 is indicated as the source of the first data packet 600 by a unique identifier ID1 601 in the IEEE 802.1AE header 603 of the first data packet 600. Furthermore, Entity 2 is indicated as the source of the second data packet 609 by a unique identifier ID2 610 in the IEEE 802.1AE header 612 of the second data packet 609. Thereby, in another embodiment data packets received from multiple entities via a shared connection may be distinguished. As in the foregoing discussion, distinct security channels may be provided for each authenticated entity to prevent spoofing attacks.

A salient feature of the described technique is that the type of identifiers in FIG. 5, that distinguish multiple entities remain accessible—e.g. readable or writable—to intermediate and endpoint network nodes whose technologies depend on such accessibility. The unique identifiers 501, 508 of the type in FIG. 5, which are external to the 802.1AE-type header, are subject to security operations of the protocol which impact the accessibility of said identifiers to downstream legacy technologies. One embodiment of the invention would protect zones of information so that the PEP may differentiate between different flows, such as TCP/IP flows or VLAN based streams. Current protocols such as the MAC Sec frame format do not allow for this.

As described above, the encryption of data packet information under current technologies such as MAC Sec constrains the use of user data. Techniques described herein may alleviate this limitation in formats such as the MAC Sec frame format. In particular, described herein is a modification to formats such as the IEEE 802.1AE format in order to accommodate legacy technologies that are already used in the field today. In one embodiment, an ability to view/read certain fields in the packet, which are obscured by security processing under IEEE 802.1AE-type formats today. An example of a technology requiring this is RSS, as described above.

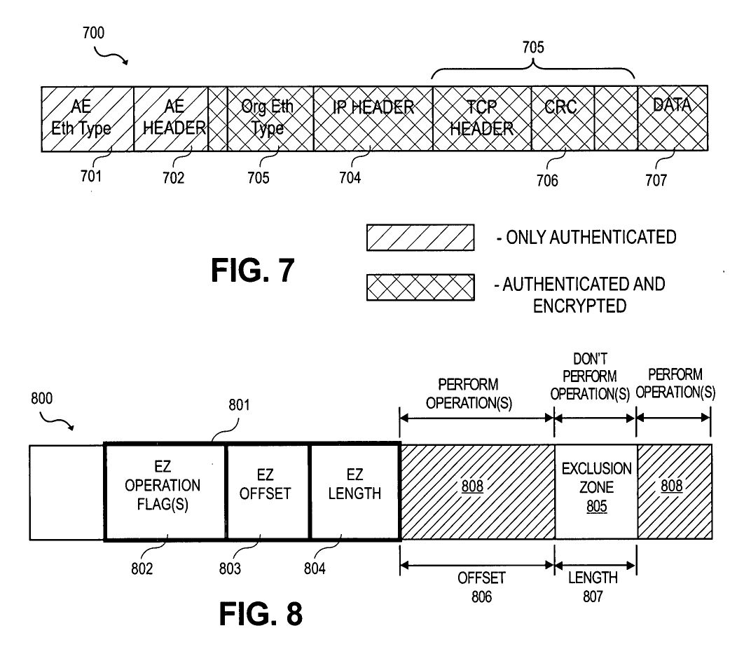

Protecting accessibility in one embodiment includes protecting an ability to write to certain fields in the packet which are also obscured by IEEE 802.1 AE-type formats today. An example of a technology requiring this protection is a TCP Offload Engine (TOE), where TCP checksums may be generated by a hardware device for performance reasons. FIG. 7 illustrates the current limitations imposed by IEEE 802.1 AE-type packet security in not allowing TCP checksum offload to be delegated to a hardware device. In one embodiment, the data packet 700 conforms to the standard IEEE 802.1AE frame format, comprising an 802.1AE ethertype field 701, an 802.1AE header 702, an original ethertype field 705, the IP header 704, the TCP header 705 (which itself contains a cyclic redundancy check field 706), and a data field 707. Some portions of the data packet 700 are omitted for abbreviation. Here the dark shaded areas indicate the encryption/authentication portion of the frame, while the light shaded area indicates the portion of the frame that is just authenticated and not encrypted. In this case a hardware device is not able to provide a service such as TCP checksum offload, because the TCP header is encrypted, and even if the TCP header was not encrypted (and just authenticated), any modification would result in an authenticated checksum (hash) failure, breaking the frame integrity.

To overcome this type of limitation and accommodate the normal function of entity identifiers in newer protocols and frame formats, the techniques described herein may be utilized to expose data in various OSI layer headers within an IEEE 802.1AE encapsulated frame. A generic format can be defined to selectively exclude or include non-contiguous portions—i.e. exclusion zones (EZ) and inclusion zones (IZ)—of the packet from one or more security operations, e.g. data encryption and/or data authentication. The techniques described herein do not require a new protocol defining EZs or IZs, but may be an extension to existing architectures such as IEEE 802.1X/802.1AE for accommodating such zones. Furthermore, an EZ can be applied for data on any OSI layer. How different embodiments of the invention extend a protocol to allow the exposure of data depends on that protocol.

FIG. 8 provides a general illustration of one format for including in a data packet information describing an EZ. In this model, the data packet 800 may be to be subjected to one or more security operations in the course of routing through a network. The source of the data packet may protect the accessibility of a portion of the data packet for use by legacy technologies. This may be accomplished by defining an EZ 805, which will be protected from a selection of the one or more security operations. To describe the EZ, an encapsulation of the data packet 800 may include an EZ header 801 comprised of a field for EZ operation flags 802, an EZ offset field 803, and an EZ length field 804. The EZ operation flags field 802 may allow an entity to indicate a specific combination of security operations from which the particular EZ is to be protected.

Examples of such security operations include data encryption and data authentication. The EZ offset field may contain the location of the EZ in relation to a reference point, e.g. the offset from the end of the EZ header 801 to the beginning of the particular EZ 805. The EZ length field may contain the size of the particular EZ 805 in a standard unit, e.g. octets. In one embodiment, this EZ header 801 information may itself remain accessible by virtue of its being an extension of the IEEE 802.1 AE header information. As a result of the encapsulation of the data packet 800 in the EZ header 801, security operations may be performed on some portions 808 of the data packet 800, but the EZ 805 may be exempted from those security operations which are indicated by the EZ operation flags 802. In one embodiment multiple EZ fields may be specified using one generic header and a series of EZ headers, each representing a discontinuous EZ range within the packet. According to one embodiment, the generic header may include a first field containing the ethertype used in describing the EZ information, and a second field describing the total count of EZ headers following the generic header. This first field of the generic header may be omitted, where the same information is contained elsewhere in the encapsulating header, i.e. elsewhere in an IEEE 802.1AE header. Each of the multiple EZ headers may have the form of the one EZ header described in the discussion of FIG. 8.

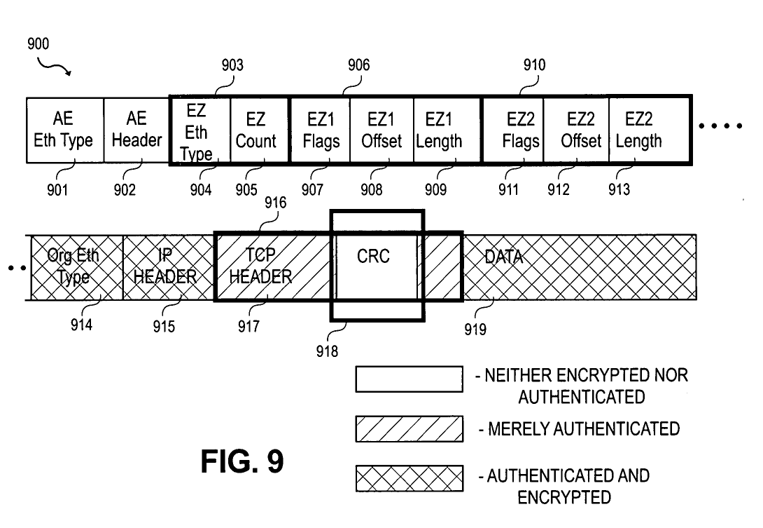

The following example illustrates multiple EZ zones in a data packet according to an embodiment of the invention whereby TCP checksum offload may be delegated to a hardware device, while maintaining IEEE 802.1AE-type packet security. FIG. 9 shows implementation of a generic header and multiple EZ headers. In this case, the data packet 900 may include EZ information as an extension of IEEE 802.1 AE header information 901, 902. Specifically, one generic header 903 and two EZ headers 906, 910 are provided. The generic header may include an ethertype field 904 and an EZ count 905, while the EZ headers 906, 910 may include the EZ operation flag field 907, 911, EZ offset field 908, 912, and EZ length field 909, 913, discussed previously.

In this example, the EZ1 header 906 may include an EZ 916 as sharing the location and size of the TCP header 917 in the data packet, and selects that EZ 916 for exclusion from data encryption only. In addition, the EZ2 header 910 may include an EZ 918 as sharing the location and size of the CRC field within the TCP header 917, and selects that EZ 918 for exclusion from data authentication. In selectively excluding these particular zones of the data packet from these particular security operation, TCP checksum offload can again be delegated to a hardware device, since the TCP header is no longer encrypted, and modifications will not result in a checksum (hash) failure. EZs may overlap, where the selection of excluded security operations for two overlapping EZs differ. In this example, the EZ2 flag field 911 may only flag the data authentication security operation since excluding EZ 918 from data encryption using the EZ2 header 910 would be redundant to the previous exclusion of that same EZ 918 from data encryption using EZ1 906.

FIG. 9 illustrates just one embodiment of a flexible encryption/integrity header. Based on the requirements, any number of uses can be generated for excluding non-contiguous chunks from within a secure frame. Note it is up to the particular usage model to ensure that the security properties of the frame are not compromised by that usage model. In another embodiment, the EZ header may just make the TCP/IP/UDP headers visible, while the integrity protection is unchanged. This provides a use case for read only applications, but the frame cannot be modified. RSS was mentioned as an example of this usage model. In yet another embodiment, just the VLAN tags may be exposed, allowing IEEE 802.1AE to work beyond the first hop.

It should be noted that the values to be used for EZ and IZ headers may be predefined or negotiated in an out-of-band (OOB) manner. One embodiment negotiates the format of EZ and IZ headers via the control channel for the protocol IEEE 802.1AF (Standard for Local and Metropolitan Area Networks—Port-Based Network Access Control—Amendment 1: Authenticated Key Agreement for Media Access Control (MAC) Security, IEEE Std 802.1AF, January 2006.). Such negotiation can include the cryptographic attributes to be used over the secure channel.

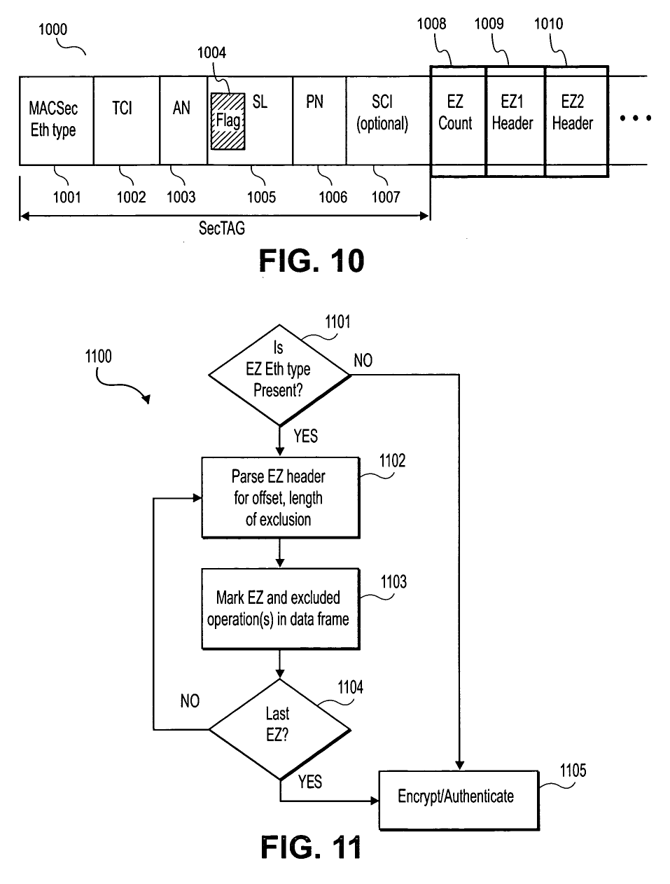

FIG. 10 shows EZ information 1008-1010 existing as an extension to an IEEE 802.1AE-type header 1000, and a flag 1004 embedded in the IEEE 802.1AE SECTag header 1001-1007 substitutes the ethertype field 904 of the generic header 903. This embodiment allows the ether type field of the generic header to be precluded in each frame. According to this embodiment, the generic header does not need an ether type field, while the EZ headers 1009, 1010 are comprised as described above. Furthermore, note that although EZ headers are used for illustration throughout this description, EZ information may be inserted in other locations, e.g. as a data packet tail.

The above discussion applies equally to both inclusion zones and to exclusion zones. Alternate embodiments may instead define an inclusion zone (IZ) for the protection of information contained in a data packet. As with exclusion zones, a data packet may be encapsulated by a header containing information describing a particular zone or multiple zones in the data packet are to be included in various individual selections of security operations. An embodiment implementing IZs may define generally the types of security operations to be performed on an IZ, and another embodiment more particularly defines any of a variety of parameters which determine the manner of execution of a selected security operations with respect to that IZ. As with exclusion zones, formats for IZs offer an extension to existing architectures such as IEEE 802.1X/802.1AE for accommodating multiple entities behind a physical port. Also, because generic capabilities for IZs are described, an IZ can be applied for data on any OSI layer. How different embodiments of the invention extend a protocol to allow the exposure of data depends on that protocol.

FIG. 11 describes a technique for marking EZs in a data packet. The technique for marking IZs in a data packet follows from FIG. 11. According to one embodiment, after determining that one or more EZs are present in the data packet 1101, a series of parsing 1102 and marking 1103 operations may be carried out. For the current EZ indicated, the offset, length and operations flags may be parsed 1102 to determine how to mark that EZ 1103.

In one embodiment, once all EZs have been marked 1104, each security operation may be executed according to the markings for the data packet 1105. In this case, the security operations may include data encryption and data authentication, and the marking indicate how the EZs in the data packet are individually excluded from selective combinations of those security operations. For an embodiment implementing IZs, the markings define a selective combination of security operations that may be performed on a given IZ, and a variety of parameters to apply in performing said operations.

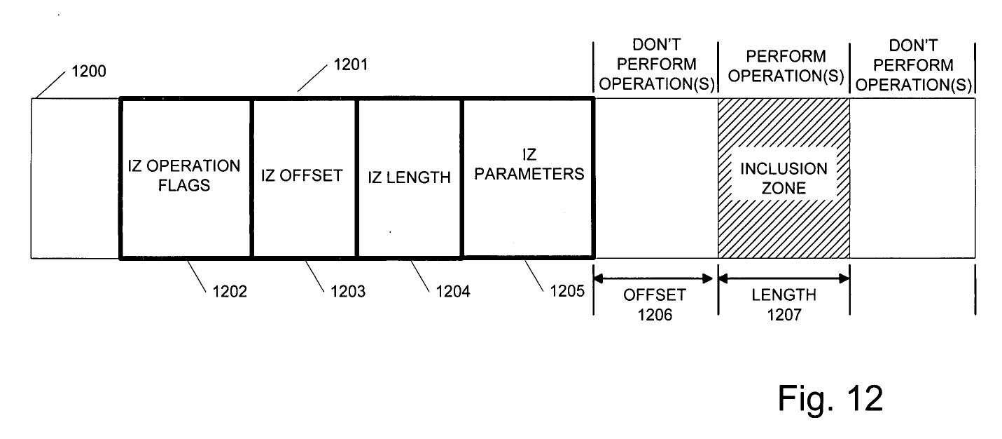

FIG. 12 provides a general illustration of one format for including in a data packet information describing an IZ. In this model, the data packet 1200 will not be subjected to one or more security operations in the course of routing through a network. The source of the data packet may define security operations to be performed on zones of the data packet for the purposes of legacy technologies. This may be accomplished by defining an IZ 1207, which will be included in a selection of the one or more security operations. To describe the IZ, an encapsulation of the data packet 1200 may include an IZ header 1201 comprised of a field for IZ operation flags 1202, an IZ offset field 1203, an IZ length field 1205, and an IZ parameters field 1205. The IZ operation flags field 1202 may allow an entity to indicate a specific combination of security operations from which the particular IZ is to be included.

Examples of such security operations include data encryption and data authentication. The IZ offset field 1203 may contain the location of the IZ in relation to a reference point, e.g. the offset from the end of the IZ header 1206 to the beginning of the particular IZ. The IZ length field 1204 may contain the size of the particular IZ 1207 in a standard unit, e.g. octets. In one embodiment, this IZ header 1201 information may itself remain accessible by virtue of its being an extension of the IEEE 802.1AE header information. As a result of the encapsulation of the data packet 1200 in the IZ header 1201, security operations will not be performed on some portions of the data packet 1200, but the IZ will be included in those security operations which are indicated by the IZ operation flags 1202. In performing the security operations on the IZ, the parameters indicated in the IZ parameter field 1205, can be passed into the security operations.

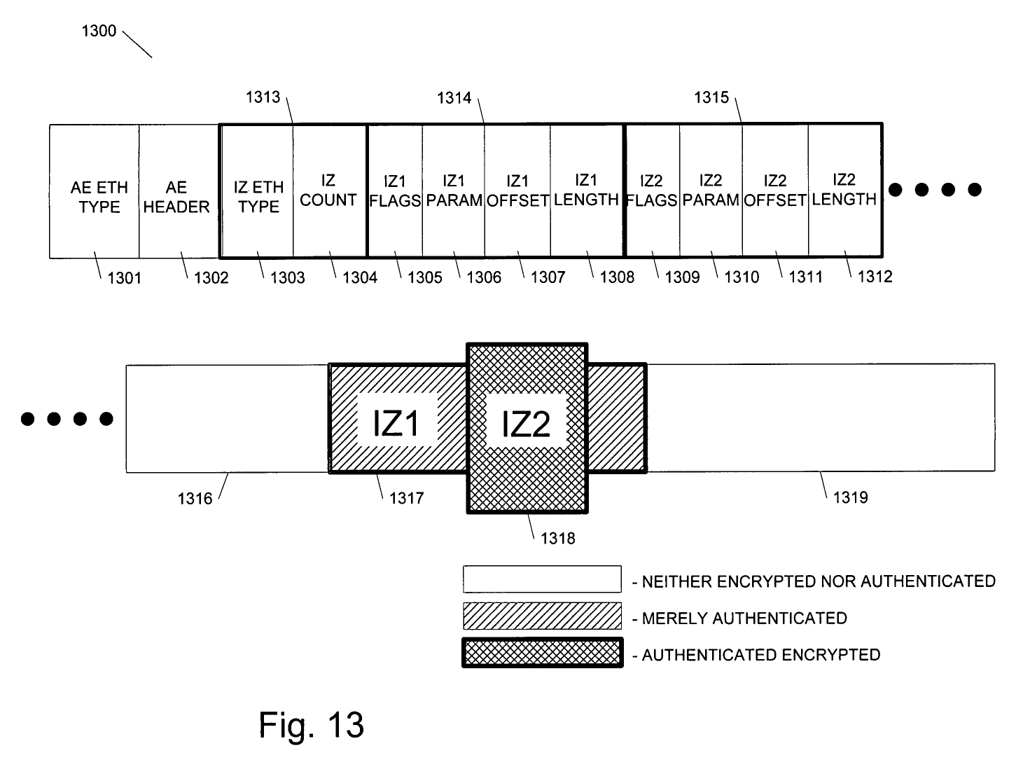

FIG. 13 shows implementation of a generic header and multiple IZ headers. In this case, the data packet 1300 may include IZ information as an extension of IEEE 802.1AE header information 1301, 1302. Specifically, one generic header 1313 and two IZ headers 1314, 1315 are provided. The generic header may include an ethertype field 1303 and an IZ count 1304, while the IZ headers 1314, 1315 may include the IZ operation flag field 1305, 1309, IZ parameter field 1306, 1310, IZ offset field 1307, 1311, and EZ length field 1308, 1312. The fields in the IZ header information corresponds to the information set forth in the description of EZ header information in FIG. 9. The differences are that the IZ header describes the exclusion of zones of data from selective combinations of security operations, and an IZ parameter field 1306, 1310 is provided to pass parameters into those security operations.

In the example of FIG. 13, the IZ1 header 1314 corresponds to an IZ1 1317, which is subjected to data authentication according to the parameters described in the IZ1 parameter field 1306. Similarly, the IZ2 header 1315 corresponds to an IZ2 1318, which is subjected to both data authentication and data encryption, each according to the parameters described in the IZ2 parameter field 1310. Note that IZs may overlap, where the selection of included security operations for two overlapping IZs differ.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a data packet encapsulated by a first zone indicator including
a description of a first zone in the data packet, and
a list of one or more security operations, the first zone in the data packet to be excluded from processing by the one or more security operations of the list; and
processing the data packet via one or more security operations, the processing according to the first zone indicator.

2. The method of claim 1 wherein the description of the first zone includes
a first field representing a location of the first zone of the data packet, and
a second field representing a length of the first zone of the data packet.

3. The method of claim 1 wherein the one or more security operations of the list include at least one of data encryption and data authentication.

4. The method of claim 1 wherein the data packet is further encapsulated by one or more additional zone indicators corresponding to one or more zones in the data packet, each additional zone indicator including
a description of a zone in the data packet corresponding to the each additional zone indicator, and
a list of security operations, the corresponding zone in the data packet to be excluded from processing by the security operations listed in the each additional zone indicator;
wherein the data packet is further encapsulated by a generic indicator including a field representing a total number of zone indicators in the data packet;
wherein the data packet is further encapsulated by an identifier signifying a protocol used to describe an exclusion of one or more zones in the data packet each from processing by one or more security operations; and
wherein the processing of the data packet is further according to the one or more additional zone indicators.

5. The method of claim 4 wherein the identifier is a field in the generic indicator

6. The method of claim 4 wherein the identifier is external to the generic header

7. The method of claim 4 wherein the protocol used to describe an exclusion of one or more zones in the data packet from processing by one or more security operations is negotiated using one of a pushed policy, an application function, and out-of-band communication.

8. The method of claim 1 wherein the first zone indicator is part of header information of the data packet.

9. The method of claim 8 wherein the header information comprises a Media Access Control header.

10. The method of claim 9 wherein the Media Access Control header conforms to the Institute of Electrical & Electronics Engineers (IEEE) 802.1AE standard.

11. The method of claim 1, the first zone in the data packet to identify as a source of the data packet one of a virtual machine, an operating system, a VLAN stream, and an electronic system configured to transmit the data packet through an aggregation device.

12. The method of claim 111 wherein the first zone in the data packet comprises at least one of a MAC address and an IP address

13. The method of claim 1, wherein the data packet is received from a first entity via a wired connection to a port, the information of the first zone to identify the first entity, the method further comprising:
receiving from a second entity via the wired connection to the port a second data packet encapsulated by a second zone indicator including
a description of a second zone in the second data packet, and
a second list of one or more security operations, the second zone in the data packet to be excluded from processing by the one or more security operations of the second list;
processing the second data packet via one or more security operations, the processing the second data packet according to the second zone indicator, the information of the second zone to identify the second entity; and
identifying the first entity based at least in part on the unprocessed information of the first zone;
identifying the second entity based at least in part on the unprocessed information of the second zone.

14. The method of claim 13 further comprising associating a set of unique security attributes to each of the first and second unique identifiers.

15. The method of claim 14 wherein the set of unique security attributes comprises a cryptographic key

16. A computerized system comprising:
a receiving unit to receive a data packet encapsulated by a first zone indicator including
a description of a first zone in the data packet, and
a list of one or more security operations, the first zone in the data packet to be excluded from processing by the one or more security operations of the list; and
a memory unit to store the data packet;
a processing unit to process the stored data packet via one or more security operations, the processing according to the first zone indicator.

17. The computerized system of claim 16 wherein the description of the first zone includes
a first field representing a location of the first zone of the data packet, and
a second field representing a length of the first zone of the data packet.

18. The computerized system of claim 16 wherein the data packet is further encapsulated by one or more additional zone indicators corresponding to one or more zones in the data packet, each additional zone indicator including
a description of a zone in the data packet corresponding to the each additional zone indicator, and
a list of security operations, the corresponding zone in the data packet to be excluded from processing by the security operations listed in the each additional zone indicator;
wherein the data packet is further encapsulated by a generic indicator including a field representing a total number of zone indicators in the data packet;
wherein the data packet is further encapsulated by an identifier signifying a protocol used to describe an exclusion of one or more zones in the data packet each from processing by one or more security operations; and
the processing unit further to process of the data packet according to the one or more additional zone indicators.

19. The computerized system of claim 16 wherein the first zone indicator is part of a Media Access Control header.

20. The computerized system of claim 16 wherein the data packet is received from a first entity, the information of the first zone to identify the first entity, the receiving unit further to receive from a second entity a second data packet encapsulated by a second zone indicator including
a description of a second zone in the second data packet, and
a second list of one or more security operations, the second zone in the data packet to be excluded from processing by the one or more security operations of the second list;
the memory unit further to store the second data packet;
the processing unit further to process the stored second data packet via one or more security operations according to the second zone indicator, the information of the second zone to identify the second entity; and
the computerized system further comprising an identifying unit to identifying the first and second entities based at least in part on the unprocessed information of the first and second zones;

21. An apparatus comprising:
a port to receive a data packet encapsulated by a first zone indicator including
a description of a first zone in the data packet, and
a list of one or more security operations, the first zone in the data packet to be excluded from processing by the one or more security operations of the list; and
a memory storage device to store the data packet;
a processor to process the data packet via one or more security operations, the processing according to the first zone indicator.

22. The apparatus of claim 21 wherein the description of the first zone includes
a first field representing a location of the first zone of the data packet, and
a second field representing a length of the first zone of the data packet.

23. The apparatus of claim 21 wherein the data packet is further encapsulated by one or more additional zone indicators corresponding to one or more zones in the data packet, each additional zone indicator including
a description of a zone in the data packet corresponding to the each additional zone indicator, and
a list of security operations, the corresponding zone in the data packet to be excluded from processing by the security operations listed in the each additional zone indicator;
wherein the data packet is further encapsulated by a generic indicator including a field representing a total number of zone indicators in the data packet;
wherein the data packet is further encapsulated by an identifier signifying a protocol used to describe an exclusion of one or more zones in the data packet each from processing by one or more security operations; and
wherein the processing of the data packet is further according to the one or more additional zone indicators.

24. The apparatus of claim 21 wherein the first zone indicator is part of a Media Access Control header.

25. The apparatus of claim 21 wherein the data packet is received from a first entity, the information of the first zone to identify the first entity, the port further to receive from a second entity a second data packet encapsulated by a second zone indicator including
a description of a second zone in the second data packet, and
a second list of one or more security operations, the second zone in the data packet to be excluded from processing by the one or more security operations of the second list;
the memory storage device further to store the second data packet;
the processor further to process the stored second data packet via one or more security operations according to the second zone indicator, the information of the second zone to identify the second entity; and
the computerized system further comprising an identifying unit to identifying the first and second entities based at least in part on the unprocessed information of the first and second zones;

26. A machine-readable medium that provides instructions, which when executed by a set of one or more processors, cause said set of processors to perform operations comprising:
receiving a data packet encapsulated by a first zone indicator including
a description of a first zone in the data packet, and
a list of one or more security operations, the first zone in the data packet to be excluded from processing by the one or more security operations of the list; and
processing the data packet via one or more security operations, the processing according to the first zone indicator.

27. The machine-readable medium of claim 26 wherein the description of the first zone includes
a first field representing a location of the first zone of the data packet, and
a second field representing a length of the first zone of the data packet.

28. The machine-readable medium of claim 26 wherein the data packet is further encapsulated by one or more additional zone indicators corresponding to one or more zones in the data packet, each additional zone indicator including
a description of a zone in the data packet corresponding to the each additional zone indicator, and
a list of security operations, the corresponding zone in the data packet to be excluded from processing by the security operations listed in the each additional zone indicator;
wherein the data packet is further encapsulated by a generic indicator including a field representing a total number of zone indicators in the data packet;
wherein the data packet is further encapsulated by an identifier signifying a protocol used to describe an exclusion of one or more zones in the data packet each from processing by one or more security operations; and
wherein the processing of the data packet is further according to the one or more additional zone indicators.

29. The machine-readable medium of claim 26 wherein the first zone indicator is part of a Media Access Control header.

30. The machine-readable medium of claim 26 wherein the data packet is received from a first entity via a wired connection to a port, the information of the first zone to identify the first entity, the operations further comprising:
receiving from a second entity via the wired connection to the port a second data packet encapsulated by a second zone indicator including
a description of a second zone in the second data packet, and
a second list of one or more security operations, the second zone in the data packet to be excluded from processing by the one or more security operations of the second list;
processing the second data packet via one or more security operations, the processing the second data packet according to the second zone indicator, the information of the second zone to identify the second entity; and
identifying the first entity based at least in part on the unprocessed information of the first zone;
identifying the second entity based at least in part on the unprocessed information of the second zone.
